(19) United States
(12) Patent Application Publication
(10) Pub. No.: US 2014/0025530 A1
(43) Pub. Date: Jan. 23, 2014

(54) System and Method for Managing Product Customization

(71) Applicants: Shawn Michael Barrieau, Chagrin Falls, OH (US); Scott James Andrews, Chagrin Falls, OH (US)

(72) Inventors: Shawn Michael Barrieau, Chagrin Falls, OH (US); Scott James Andrews, Chagrin Falls, OH (US)

(21) Appl. No.: 14/034,343

(22) Filed: Sep. 23, 2013

Related U.S. Application Data
(63) Continuation of application No. 13/405,298, filed on Feb. 25, 2012.
Application No. 13/405,298 is a continuation of application No. 11/497,541, filed on Jul. 31, 2006, now abandoned.
(60) Provisional application No. 60/703,959, filed on Jul. 30, 2005.

(51) Int. Cl. G06Q 20/34

(52) U.S. Cl. CPC G06Q 20/355
USPC 705/26.5

(57) ABSTRACT

Systems and methods for managing the customization of products can be implemented to facilitate the cooperative efforts of sellers, buyers, and producers of customizable products through a common, loosely coupled, remote system. This system may be implemented via a web-based software system as a hosted solution or as an easily integrated solution to the existing web presence of the seller.

### CROSS-REFERENCE TO RELATED APPLICATIONS

Priority is claimed to Provisional Application No. 60/703,959, filed Jul. 30, 2005.

### BACKGROUND

This invention relates generally to electronic commerce. More specifically, the invention relates to systems and methods for facilitating the customization of products over a computer network.

Products such as gift cards, credit cards, greeting cards, and other merchandise are available for purchase in customized fashion. Such customized products have been available for some time in traditional brick and mortar retail establishments. For example, customers may travel to a T-shirt silk screening producer and request a T-shirt with the customer's own personalized message or graphic design. However, the traditional brick and mortar customization method is inconvenient for buyers of such merchandise because they must physically travel to the seller's location.

Customized products are also available for purchase over the Internet. For example, customers may order customizable gift cards from retail chains with the customer's own uploaded image placed on the card. These existing systems have the disadvantage of requiring the seller of the customized product to install and maintain software. These online product customization services also tightly couple the process of creating the customized design directly to other aspects of the overall transaction. For example, such systems include the need to collect and maintain customer billing information. Some such systems even couple the physical product production system to the customization design system. One disadvantage of such tightly coupled systems is that sellers and producers who have existing billing and production systems but who wish to begin providing online customization for the first time must now maintain two separate systems with overlapping functionality. Another disadvantage of such tightly coupled systems is that the complexity of these systems and their interconnectedness make it difficult to update only the portion of the system that directly relates to the design of a customized product.

Therefore, in light of these problems, there is a need for a system and method for allowing buyers, sellers, and producers of customized merchandise to interact cooperatively toward the design of customized products via a common, loosely coupled, remote system.

### BRIEF SUMMARY

The systems and methods of the present application allow sellers to offer product customization to buyers without having to build the customization technology necessary to create the customized digital images or the system to support the safe and approved delivery of customized images to the final destination such as a production facility or data store.

The systems and methods further allow sellers to identify and configure one or more products available for customization by specifying attributes of each product, including attributes that are customizable by buyers of the products and attributes that are not customizable by the buyers of the products.

The systems and methods further allow sellers to configure the production options for each product available for customization, including which producer to send the production request and other aspects germane to producing the physical customizable product.

The systems and methods further allow sellers to review customization requests specified by buyers before such customization requests are released to the producers of customized products.

In one embodiment the systems and methods may be implemented as a hosted solution, creating a seamless connection between the seller's website, the buyers of customized products, and the producers of customized products.

In another embodiment a portion of the systems and methods directed to providing an interface for buyers to specify their customization request may be implemented as an easily integrated plug-in module.

In another embodiment a portion of the systems and methods directed to providing an interface for buyers to specify their customization request may be implemented with the seller's existing customer interface and may be easily integrated with the systems and methods of the present application via the defined specification of these systems.

### BRIEF DESCRIPTION OF THE DRAWINGS

FIGS. 1A and 1B are a high-level conceptual view, and a detailed conceptual view, respectively, of a product customization management system and method.

FIG. 2A is a method for managing the customization of products.

FIGS. 2B through 2D are sub-processes of the method depicted in FIG. 2A.

FIG. 3 is a schematic drawing of hardware systems networked for product customization management according to an embodiment of the present invention.

FIGS. 4A through 4D are views of exemplary screens viewable by sellers on a web-based graphic user interface accessing a software implementation of the product customization management system according to an embodiment of the present invention.

### DETAILED DESCRIPTION

The systems and methods described herein provide for the customization of products through the cooperative efforts of sellers, buyers, and producers via a common system.

As used herein, products may include but are not limited to the following tangible articles of manufacture: gift cards, credit cards, loyalty cards, identification cards, business cards, greeting cards, pens, mugs, shirts, and any other product capable of being imprinted with images or text. Products may further include but are not limited to intangible products such as digital media including images, motion picture files, animation, and the like.

Product attributes may include both customizable product attributes and non-customizable product attributes. Customizable product attributes are available for buyers of customized products to customize per available customization options. Non-customizable product attributes are content and specifications determined by the seller of customized products for which buyers of such products may not alter with further customization.

Product attributes include but are not limited to the following categories of content: uploaded images, stock images, specified text, and stock text. Images may include any form of graphic representation, such as but not limited to pictures, designs, icons, or solid colors. Product attributes may also include the specifications for determining allowable locations for customizable and non-customizable content on the surface area of the product. Product attributes may further include but are not limited to the following methods of allowable customization of customizable content: re-size, crop, rotate, locate, change font, font size, and draw line.

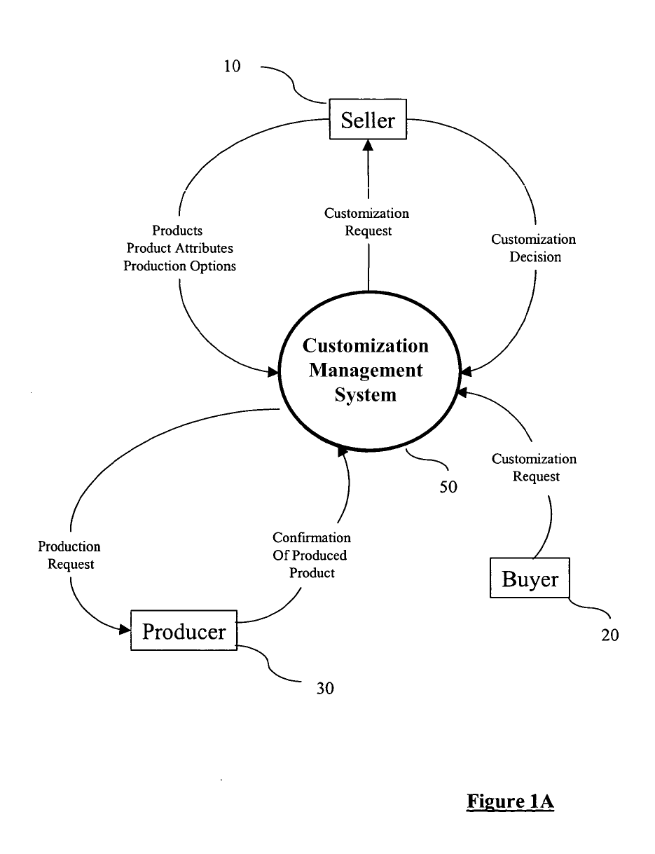

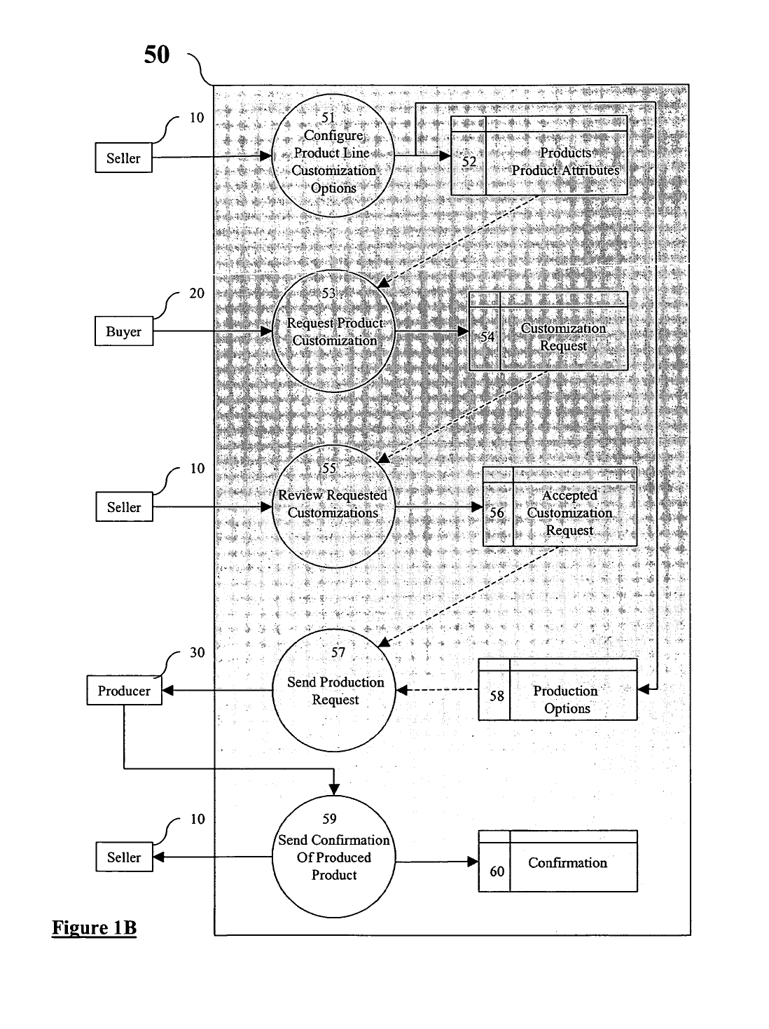

Referring now to FIG. 1A, a high-level conceptual view of one embodiment of a system and method for managing product customization will be described. As shown in FIG. 1A, a customization management system (“the system”) 50 facilitates the cooperative activities of three remote groups that are party to a product customization process: sellers 10, buyers 20, and producers 30.

FIG. 1B provides a more detailed conceptual view of customization management system of FIG. 1A. FIG. 1B illustrates various sub-routines and data stores of the system 50 as well as the parties' interaction with these sub-routines and data stores to facilitate multi-party product customization. As shown in the embodiment of FIG. 1B, subroutines collect data, data is collected, stored in data stores, and accessed by subroutines at its various stages of development within the data stores of the system 50.

Dashed lined arrows in FIG. 1B indicate data being read by a process within the system 50, whereas solid lined arrows shown within the system 50 of FIG. 1B indicate data writes to the data record stored in the system 50. Solid line arrows to and from the system 50 illustrate the interaction of the various parties with sub-processes of the system 50.

As shown in FIG. 1B, sellers 10 configure product line customization options utilizing subroutine 51 and store a data record in data store 52 of the system 50, including data fields sufficient to identify and describe products, product attributes, and production options.

Buyers 20 request product customizations utilizing subroutine 53, resulting in the storage of a data record in data store 54 of the system 50 containing data fields sufficient to identify and describe the product selected, attributes of this product, and proposed customizations to customizable attributes of the product.

Sellers 10 utilize subroutine 55 to review selected product customization requests and store their acceptance decision in data store 56 as an additional data field in the data record defining each such selected product customization request stored in the system 50.

Subroutine 57 reads data store 56 and 57 and sends formatted production requests to the specified producers 30 of each accepted product customization request based on the data record defining each accepted product customization request and data stored in the system identifying and describing production options, which include the identity and contact information of available production venders, and may include price, volume, and delivery information, as well as other information that one of skill in the art might deem necessary or important.

Finally, producers 30 send confirmation of produced products to sellers 10 via subroutine 59, which stores a record of the confirmation in subroutine 60.

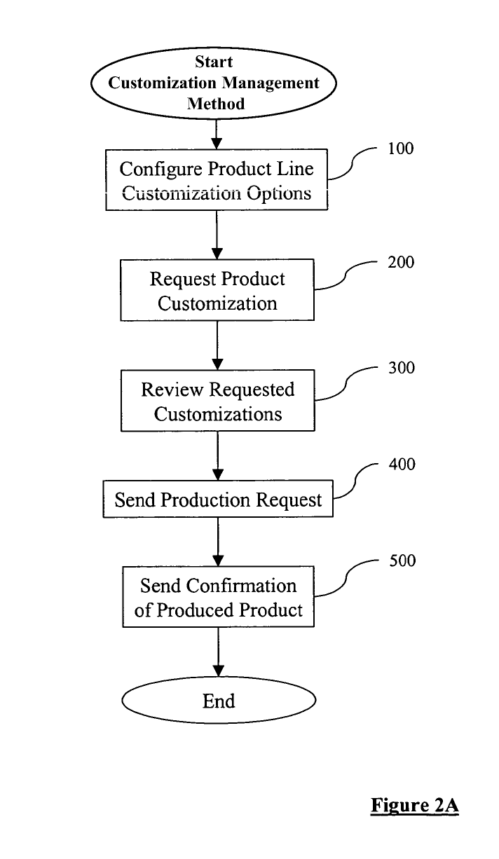

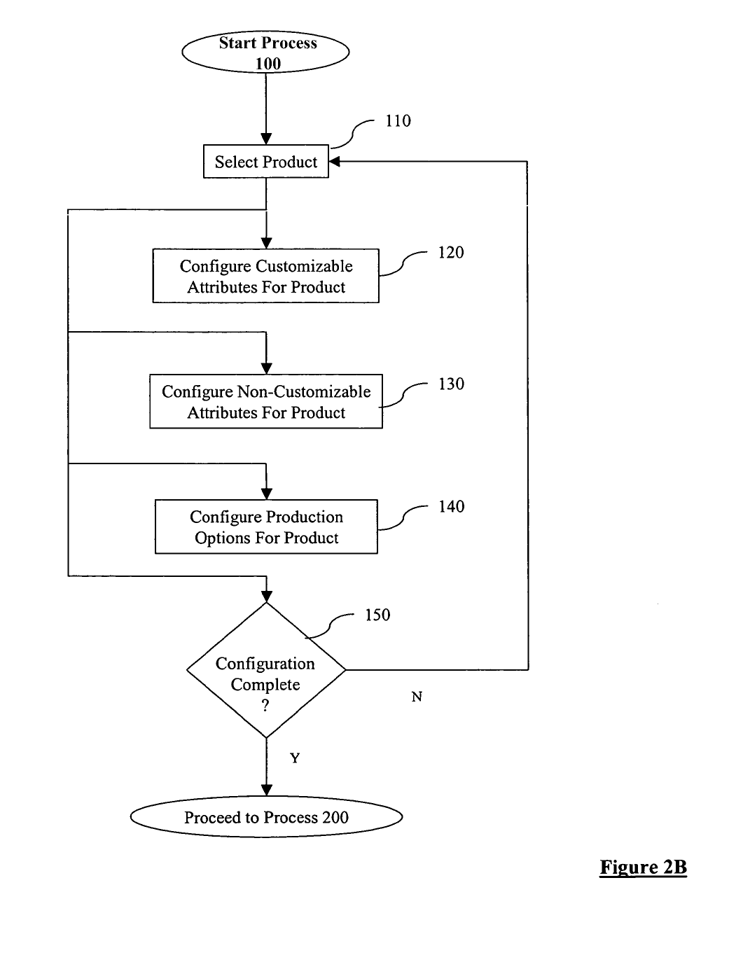

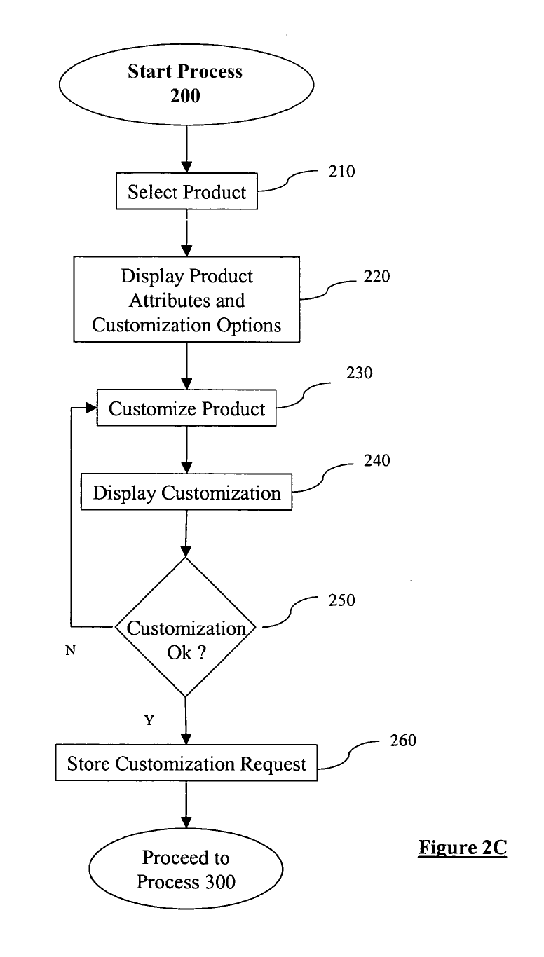

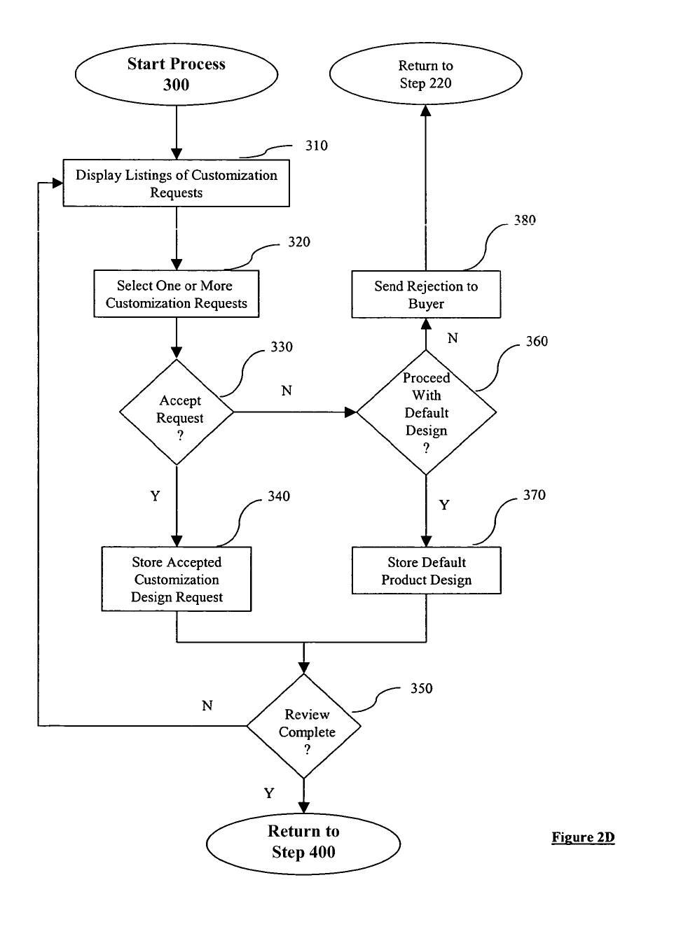

A method of managing product customization will now be described in detail. Referring to FIG. 2A, process steps in the method include the following: configure product line customization options 100, request product customization 200, review proposed customizations 300, send production request 400, and send confirmation of produced product 500.

One embodiment of process 100 is illustrated in detail in FIG. 2B. In this embodiment, the seller 10 of customizable goods configures its product line for customization by buyers of the customizable goods. Essentially, this process involves determining which products a given seller wants to make available for customization, and which attributes or aspects of those products the seller wants to make available for—for example. A certain portion of one side of a credit or gift card, which customization the seller wants to fix on a given product such that it cannot be removed by a buyer during the customization process, which customization options the seller wants to make available to a buyer for use on a given product, and what parameters will govern the configurable options the seller will permit a buyer to upload and place on a given product.

As shown in FIG. 2B, step 110 of process 100 entails selecting a customizable product from the collection of products available for receiving customization.

As further shown in FIG. 2B, the following steps may occur in parallel: configure customizable attributes for the selected product 120, configure non-customizable attributes for the selected product 130, and configure production vendor options for the selected product 140.

In step 120 of process 100, the seller configures customizable product attributes by selecting a customizable product attribute from a collection of customizable product attributes available for the selected product.

Also included in step 120 is the activity of saving the configured customizable product attributes in a data record contained in a data store of the system 50.

In step 130 of process 100, the seller configures non-customizable attributes. Step 130 allows a seller to place certain content on a certain type of customizable product, for which a buyer of such product would not have the ability to modify. For example, a seller may wish to place a certain border on all customizable gift cards that includes the seller's logo and text. In another example, a seller may wish to select a stock background color for the customizable portion of a business card.

Also included in step 130 is the activity of saving the configured non-customizable product attributes in a data record contained in a data store of the system 50.

In step 140 of process 100, the seller 10 configures production options by selecting a product vendor available for the selected product from the collection of product vendor available for the selected product. This may include contact information, shipping parameters, volume-price information, discount information, production time frames, and the like. Also as part of step 140 the seller 10 specifies any other product-specific information necessary for production of a customized product.

Also included in step 140 is the activity of saving the production options in a data record contained in a data store of the system 50.

In step 150 of process 100, the seller determines whether product line configuration is complete. If no, meaning that the seller wishes to configure additional products in the product line or wishes to re-configure an already configured product then the process returns to step 110 of process 100. If the seller decides in step 150 that the product line is configured, then the process proceeds to process 200.

Turning now to FIG. 2C, one embodiment of process 200 is depicted. In this embodiment, the buyer 20 of customizable goods requests product customization. The buyer does this by using any communication device capable of accessing an Internet web site through a graphics-based browser, including a computer, television, telephone, PDA, and any other similar mobile or other device.

In step 210 of process 200 the buyer selects a product for receiving a customized image from the collection of products available for receiving customizable images. This is accomplished by the buyer viewing graphical representations of the available products or portions thereof through a browser.

In step 220 of process 200 the product attributes and customizable options of the selected product are displayed to the buyer. This may be done serially or in parallel.

In step 230 of process 200 the buyer customizes the selected product by selecting a selectable customization option for placement in the selected customizable product attribute of the selected product from the collection of selectable customization product options such that a design of a customized product is produced.

In step 240 of process 200 the design of the customized product is displayed for the buyer for review. The customer evaluates the displayed customized product design in step 250 of process 200. If the buyer the buyer wishes to perform additional customization or to revise a customization already specified then the process begins again at step 230 of process 200.

Once the buyer is satisfied with the design of the customized product at step 250 of process 200 then the buyer's customization request is stored in the system 50 along with customer contact information through step 260.

Turning now to FIG. 2D, one embodiment of process 300 is depicted. In this embodiment, the seller 10 of customizable goods reviews requested customizations stored in the system 50 by buyers 20 during process 200.

In step 310 of process 300 listings of customization request are displayed by the system 50 for review by the seller 10.

In step 320 of process 300 the seller 10 selects one or more product customization requests for review.

In step 330 of process 300 the seller 10 determines whether to accept or reject the selected product customization requests.

If the seller's decision at step 330 is to accept the customization decision, then the system 50 stores the accepted customization design request in step 340. The seller 10 may then decide whether review is complete, step 350. If so, proceed to process 400 and if not return to step 310 of process 300.

If the seller's decision in step 330 is not to accept the selected product customization design request, then the seller 10 must decide whether to proceed with a default design, step 360. If yes, then the system 50 stores the default product design, step 370, and the seller 10 proceeds to step 350 described above. Conversely, if the seller 10 decides not to proceed with a default design in step 360, then a rejection is sent to the buyer in step 380. Under this scenario, the buyer is invited to return to step 220 of process 200 to re-attempt to request a product customization design. In one embodiment of step 380, the notification of rejection is sent to an email address, which was saved back in step 260, along with a hyperlink to a URL wherein the buyer's earlier selected product is displayed along with attributes and customizable options pursuant to step 220.

In process 400, a production request is sent to the appropriate producer 30 as determined by the production options configured by the seller in step 140 of process 100. The request contains information sufficient to identify the product, customizable and non-customizable product attributes, the requested or default product customization design, and production options.

In process 500, the producer 30 in receipt of a production request completes production of the produced product and sends confirmation of the produced product to the seller 10.

As understood by one of ordinary skill in the art, the system and method for managing product customization may be implemented in computer software using a range of computer programming technologies including JAVA, XML, Flash, Ruby, C, C#, ASP, Visual Basic, JavaScript, VB Script, and the like. The inventors have found that a combination of Java, XML, Flash, and Ruby are the preferred technologies, but other of skill in the art may find other technology more suitable.

As understood by one of ordinary skill in the art, the computer software described above can be run on a variety of microprocessor based hardware devices capable of connecting the internet. Sellers 10, buyers 20, and producers 30 can be connected to such hardware devices via the Internet.

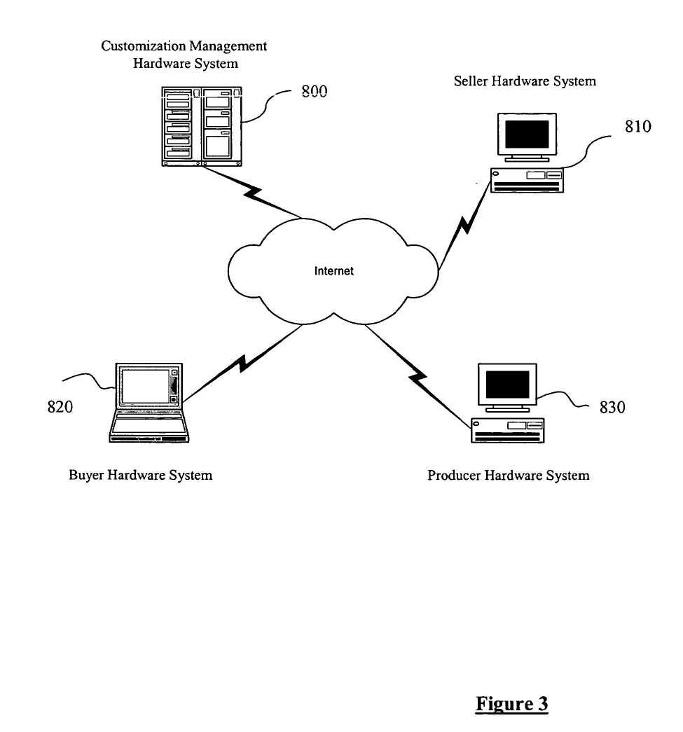

One embodiment of such hardware systems is shown in FIG. 3, the customization management hardware system 800 is connected to the seller hardware system 810, the buyer hardware system 820, and the producer hardware system 830. As would be apparent to one of ordinary skill in the art hardware systems 810, 820, and 830 could include any hardware system capable of connecting navigating to an Internet web site through a graphics-based browser, including a computer, television, telephone, PDA, and any other similar mobile or other device.

Using programming technologies and hardware systems such as those described above, embodiments of the systems and methods may allow access to users via a browser-based user interface for displaying a graphical representation of at least a portion of a product available for receiving customized images, a customizable product attribute of said product, and a selectable customization option for said product.

Embodiments of the systems and methods may also include a remote means for storing data, including images of products available for receiving customizable images, customizable product attributes available for each of said products, selectable customization options for each of said products, and product vendors for each of said products. As understood by one of ordinary skill in the art, the remote means for storing data can include a wide variety of data storage technologies, including storing data records in a wide variety of data stores, including but not limited to the following: relational database, hierarchal database, flat file, XML, heap, linked list, or other storage means.

Implemented with the technologies describe above as well as other technologies known in the art, embodiments of the remote means for storing may also include a means for receiving instructions for selecting a product from the products available for receiving customizable images, for selecting a customizable product attribute available for the selected product from a list of customizable product attributes, for selecting a selectable customization option for placement in the selected customizable product attribute of the selected product such that a design of a customized product is produced, and for storing the design of the customized product.

Also implemented with the technologies describe above as well as other technologies known in the art, one embodiment of the remote means for storing may also include a means for reviewing the design of the customized product, accepting the design of the customized product, sending a production requests to a product vendor for the customized product, and sending confirmation of production of the customized product.

As apparent to one of ordinary skill the art, the systems and methods for customizing images may be implemented to include an Internet communications link coupling the user interface to the remote means, said link being operative to communicate instructions from the user interface to the remote means and information reflecting the results of said instructions from the remote means to the user interface.

In one embodiment, these systems and methods are implemented as a hosted solution. In another embodiment these systems and methods and parts thereof are implemented as an easily implemented plug-in module that interfaces with the seller's system. For example, the process and method of providing a means for buyers to design and request customizations may be implemented as a plug-in module.

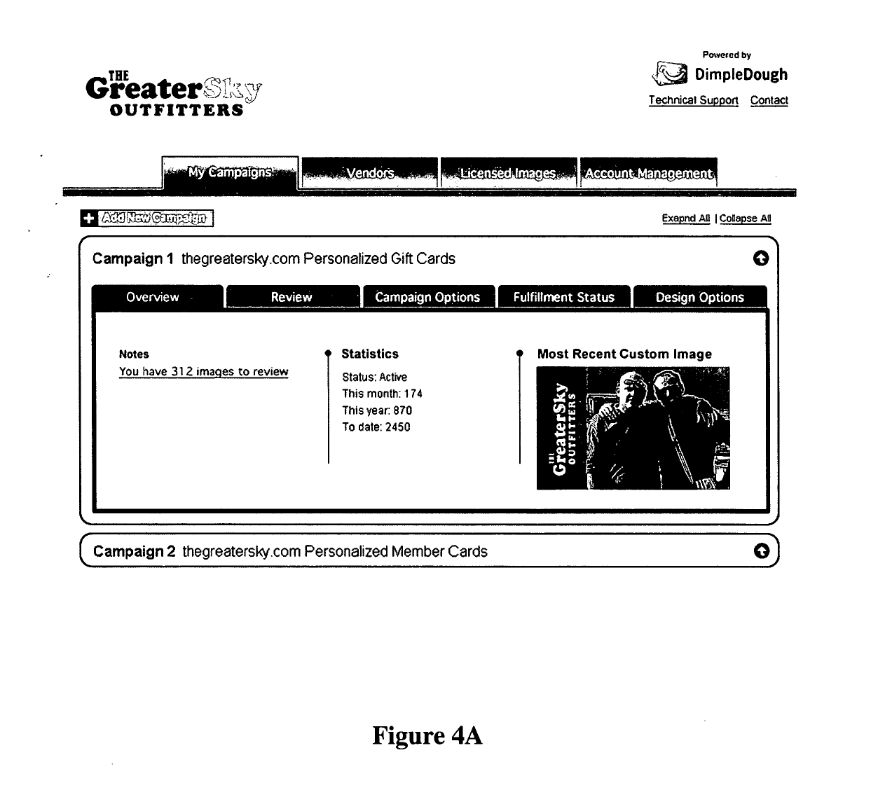

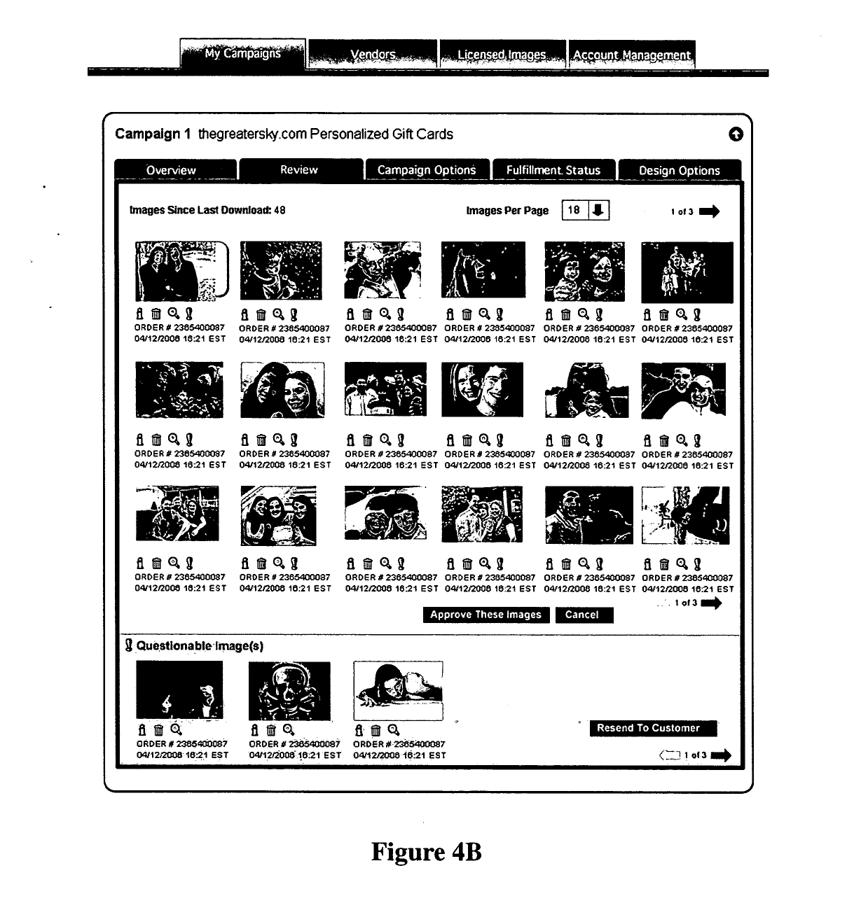

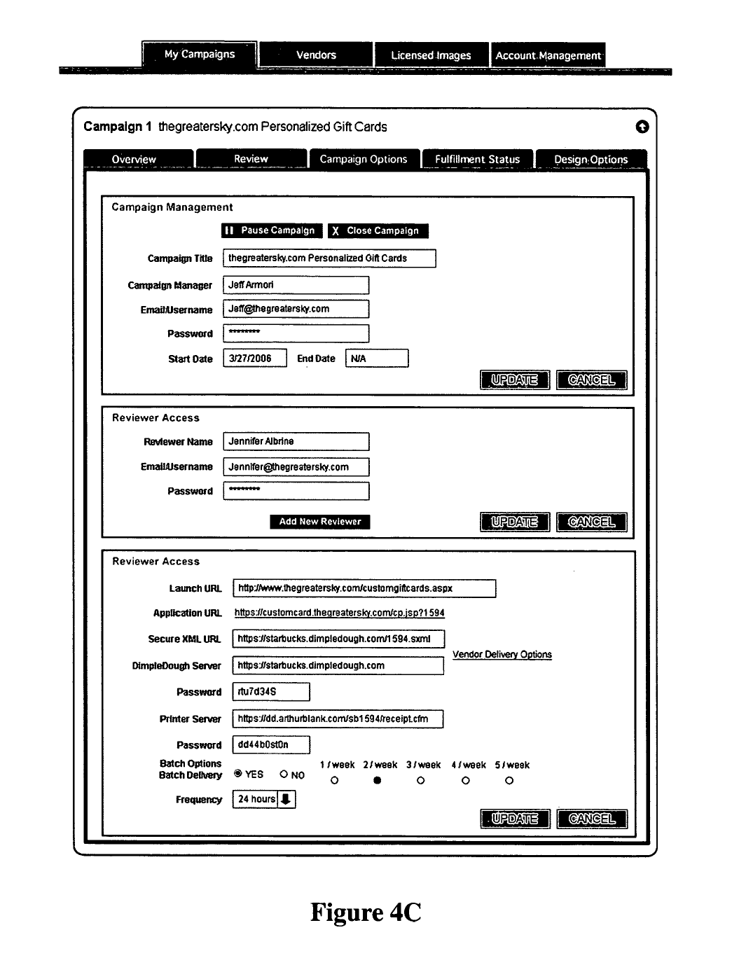

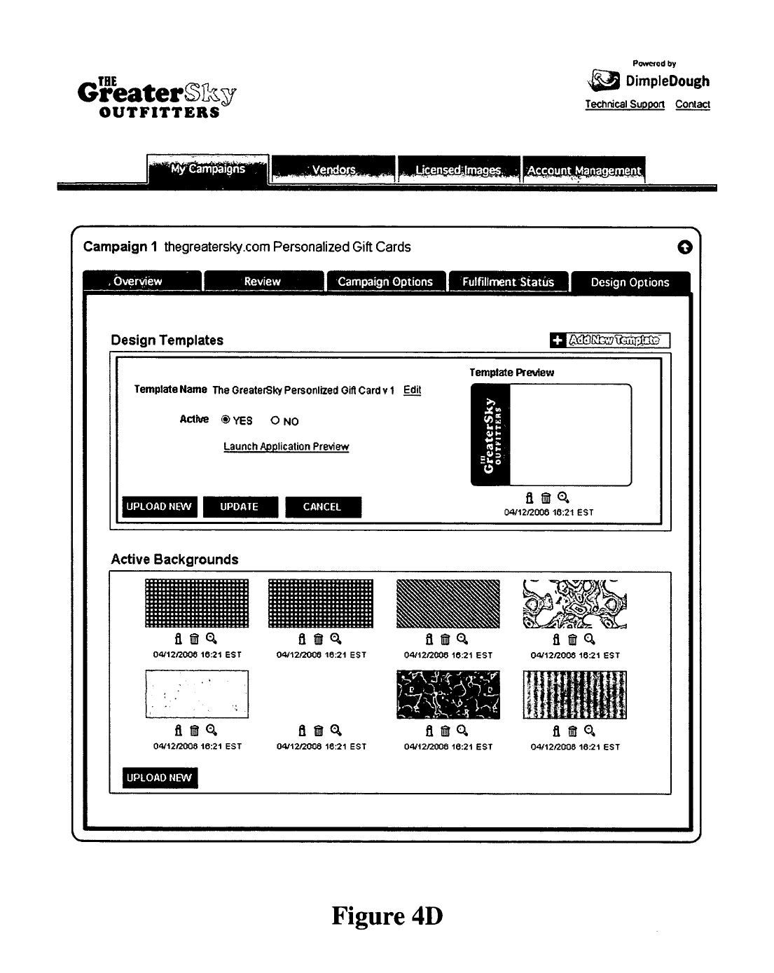

Finally, a software implementation of system 50 will be described. Turning to FIG. 4A, a view of a web-based graphic user interface is provided for sellers 10 to access the system 50.

FIG. 4B illustrates an embodiment of process 300, wherein a graphic user interface is provided to allow a seller 10 to review requested customizations.

FIGS. 4C and 4D illustrate an embodiment of process 100, wherein a graphic user interface is provided to allow a seller 10 to configure product line customization options.

What is claimed is:

1. A computer automated business method for providing a pre-paid card producing system to a retailer for their use in selling user-customizable pre-paid cards produced on demand for users who are customers of the retailer, the method comprising the steps of:
providing a software service that assists a retailer in designing and implementing a retailer-specific pre-paid card producing system by:
enabling retailer selection of providers of one or more pre-paid card-producing functions; and
integrating selected providers to implement a retailer-specific pre-paid card producing system.

2. The method of claim 1, further comprising the steps of:
providing the retailer with a computer-implemented software framework that interfaces with customers of the retailer to enable their custom designing and purchasing of the retailer's pre-paid cards, wherein designing includes an option of uploading a customer provided image for inclusion in a design concept that is printed on the pre-paid card;
determining a set of pre-qualified providers of pre-paid card-producing functions including:
a provider of online purchasing functions;
a card layout service that converts a given design concept into an output suitable for printing on a pre-paid card;
a provider of financial services for implementing and tracking the use, function and accounting of a pre-paid monetary value associated with the pre-paid card;
a printing service or a physical printer of pre-paid cards; and
a printed card delivery service; and
inter-connecting the selected providers with each other and with the retailer's accounting system such that the customized pre-paid card producing system will automatically function as a background process under the overall control of the retailer according to his customized design.

3. The method of claim 1, further comprising the step of:
establishing an internet based, computer automated software service (SaaS) for implementing the steps of the method.

4. A computerized software service (SaaS) that customizes pre-paid card producing systems for retailers, the service comprising:
an internet based, computer automated service that assists a retailer in designing and implementing a retailer-specific pre-paid card producing system by:
enabling retailer selection from a list of providers of pre-paid card-producing functions; and
integrating selected providers to implement a retailer-specific pre-paid card producing system.

5. The service of claim 4, further comprising:
a computer-implemented software framework provided to the retailer for interfacing with customers of the retailer to enable their custom designing and purchasing of the retailer's pre-paid cards, wherein designing includes an option of uploading a customer provided image for inclusion in a design concept that is printed on the pre-paid card;
pre-qualification of the listed providers, wherein the list includes providers of pre-paid card-producing functions including:
a provider of online purchasing functions;
a card layout service that converts a given design concept into an output suitable for printing on a pre-paid card;
a provider of financial services for implementing and tracking the use, function and accounting of a pre-paid monetary value associated with the pre-paid card;
a printing service or a physical printer of pre-paid cards; and
a printed card delivery service.

6. The service of claim 4, further comprising:
inter-connection of the selected providers with each other and with the retailer's accounting system such that the pre-paid card producing system will automatically function as a background process under the overall control of the retailer according to his customized design.
